(19) United States
(12) Patent Application Publication
(10) Pub. No.: US 2008/0255958 A1
(43) Pub. Date: Oct. 16, 2008

(54) Approach for trading copyrighted movie or music clip as individual copyrighted frame

(76) Inventor: Hoang Bui, (US)

Correspondence Address: HOANG X. BUI, 13174 TORRINGTON DR., FRISCO, TX, 75035, US

(21) Appl. No.: 11/733,575

(22) Filed: Apr. 10, 2007

(51) Int. Cl. G06Q 30/00; G06Q 90/00

(52) U.S. Cl. 705/27; 705/500; 705/26

(57) ABSTRACT

According to the approach, a copyrighted movie or music clip can be divided into in individual copyrighted movie frame or clip in it plural form. Each frame then can be sold or traded as independent copyrighted item. The “dividend” approach allows each frame owner to share the loyalty money of the whole movie or music clip. The “contract right” governs the right to approved loyalty contract. The “buyout right” governs the right to buy all remaining frame of the movie or clip.

### FIELD OF THE INVENTION

The present invention related to trading, and more specifically, to an approach for trading copyrighted movie frames.

### BACKGROUND OF THE INVENTION

Conventionally, copyrighted movie or music clip is traded as a single entity for the whole movie or clip. These types of trading suffer from several limitations. First, copyrighted movie or music clip are expensive so small investor/collector does not have a chance to own them. Second, there is a significant risk for owning a single movie music clip since it value can move up or down drastically. Furthermore, there is no method to distribute loyalty of a movie or music clip to individual frame in form of dividend.

Given the current demand from small investor/collector to own movie frame and the limitation in the prior approach, an approach for trading movie that does not suffer from traditional movie trading is highly desirable. In particular, an approach of dividing a movie or music clip into individual movie frame so that small investor/collector can own and earn loyalty or dividend is highly desirable.

Further the new approach introduces loyalty contract right and buyout right as a method to put all frames together for loyalty contract or selling by the majority of frame owners.

The invention claimed is:

1. A method for trading a copyrighted movie or music clip as individual copyrighted frame, the method comprising: provide information on one or more attribute of the frame; provide copyrighted information; provide registered information; provide media information.

2. A method according to claim 1, wherein said provide information on one or more attribute of the frame includes production information.

3. A method according to claim 1, wherein said provide information on one or more attribute of the frame includes the movie studio, release year, and actor/actress information.

4. A method according to claim 1, wherein said provide information on one or more attribute of the frame includes history of the movie.

5. A method according to claim 1, wherein said provide information on one or more attribute of the frame includes price information.

6. A method according to claim 1, wherein said provide information on one or more attribute of the frame includes digital image.

7. A method according to claim 1, wherein said provide information on one or more attribute of the frame includes information on total number of frame in the movie.

8. A method according to claim 1, wherein said provide copyrighted information includes the copyright privilege of the owner.

9. A method according to claim 1, wherein said provide registered information includes the register of owner name, address, and phone number.

10. A method according to claim 1, wherein said provide registered information includes the frame id.

11. A method according to claim 1, wherein said provide the media information includes type of media to keep the copyrighted frame.

12. A method for dividing a copyrighted movie right into in individual copyrighted frame right, the method comprising: provide dividend ratio; provide the loyalty contract right; provide the buyout right.

13. A method according to claim 12, wherein said provide dividend ratio includes the ratio royalty dividend the owner will earn from the whole movie or music clip loyalty contract.

14. A method according to claim 12, wherein said provide the loyalty contract right includes the thread hold of majority vote needed from each frame owner to approve the loyalty contract for all frame.

15. A method according to claim 12, wherein said buyout right includes the thread hold of majority vote needed from each frame owner to approve the buyout contract for all frame at a fair market price.

16. An electronic trading system for trading copyrighted frame, comprising: purchase order screen; sell order screen; submit order screen; order information screen.

17. A system according to claim 16, wherein said provide purchase order screen includes order type and price information screen.

18. A system according to claim 16, wherein said sell order screen includes order type and price information screen.

19. A system according to claim 16, wherein said submit order screen includes order information and user option screen.

20. A system according to claim 16, wherein said order information screen includes order status screen.
